(19) United States
(12) Patent Application Publication
(10) Pub. No.: US 2017/0066257 A1
(43) Pub. Date: Mar. 9, 2017

(54) RECORDING METHOD

(71) Applicant: SEIKO EPSON CORPORATION, Tokyo (JP)

(72) Inventor: Junhua ZHANG, Shiojiri (JP)

(21) Appl. No.: 15/252,946

(22) Filed: Aug. 31, 2016

(30) Foreign Application Priority Data
Sep. 4, 2015 (JP) 2015-174440

(51) Int. Cl. B41J 11/00

(52) U.S. Cl. CPC B41J 11/0015

(57) ABSTRACT

A recording method performs recording by applying an ink to a recording medium, the method including pretreatment step that applying a pretreatment liquid having thixotropy to the recording medium; and recording step that applying the ink to the recording medium to which the pretreatment liquid is applied.

### BACKGROUND

1. Technical Field

The present invention relates to a recording method which forms an image by applying an ink to a recording medium.

2. Related Art

Technological development for giving a recorded image still higher image quality and higher quality is progressing in recording methods that record (print) images with an ink jet method. For example, JP-A-2010-142965 discloses an image forming method which coats a recording medium in advance with a treatment liquid capable of causing ink components to aggregate or thicken. According to the method, it is possible to prepare a favorable printed matter with high sharpness and without graininess or bleeding.

However, in the image forming method disclosed in JP-A-2010-142965, it is necessary for the ink to include a resin having an acid group saturated by ammonia and for the treatment liquid to have an undissolved component acting at the solids in the ink, and important for both of the ink and the treatment liquid to include a component that reacts with each. That is, the image forming method disclosed in JP-A-2010-142965 has a problem in that the range of effects obtained is limited.

### SUMMARY

The invention can be realized in the following aspects or application examples.

### Application Example 1

According to an application example, there is provided a recording method that performs recording by applying ink to a recording medium, the method comprising pretreatment step that applying a pretreatment liquid having thixotropy to the recording medium; and recording step that applying the ink to the recording medium to which the pretreatment liquid is applied.

According to this application example, the ink applied in the recording step is applied to the recording medium on which the pretreatment liquid having thixotropy is applied. The behavior of the ink applied to the recording medium can be controlled based on the thixotropy of the pretreatment liquid. That is, the degree of spreading and movement of the ink can be controlled in response to the thickening characteristics of the pretreatment liquid. That is, aggregation or bleeding of the ink can be suppressed without including a component that reacts with both of the pretreatment liquid and the ink.

### Application Example 2

In the recording method according to the application example, the pretreatment liquid is applied to the recording medium at predetermined intervals, in the pretreatment step.

According to this application example, the ink applied in the recording step is applied to the recording medium on which the pretreatment liquid having thixotropy is applied at predetermined intervals. Therefore, in a case where the viscosity of the pretreatment liquid when the ink is applied is high enough to prevent spreading or movement of the ink, aggregation of the ink can be suppressed by the pretreatment liquid applied at predetermined intervals.

### Application Example 3

In the recording method according to the application example, in the pretreatment step, the pretreatment liquid is applied at a position according to a recording which is recorded in the recording step.

According to this application example, the pretreatment liquid having thixotropy is applied to a position according to the recording which is recorded in the recording step. Therefore, the pretreatment step can be shortened or the consumption amount of the pretreatment liquid can be reduced by applying the pretreatment liquid only to a sufficient range in which recording is necessary. For example, by applying the pretreatment liquid only to the range in which the effects or influence due to the pretreatment liquid is expected, the width of expression in the recording can be widened.

### Application Example 4

In the recording method according to the application example, in the pretreatment step, a density at which the pretreatment liquid is applied changes based on the recording which is recorded in the recording step.

According to this application example, the pretreatment liquid having thixotropy is applied at a density based on the recording which is recorded in the recording step. That is, because the pretreatment liquid can be applied at a density in response to the degree of effect or influence expected due to the pretreatment liquid, the degree of aggregation or bleeding of the ink can be controlled in response to the specification of the recorded image. As a result, it is possible to widen the width of expression during recording.

### Application Example 5

In the recording method according to the application example, the pretreatment liquid has affinity to the ink.

According to this application example, because the pretreatment liquid has affinity to the ink, the action of the pretreatment liquid with respect to the ink can be made more stable. Because the fixability of the ink is further increased, the durability of the recording can be further increased.

### Application Example 6

In the recording method according to the application example, the pretreatment liquid includes a solvent included in the ink.

According to this application example, because the pretreatment liquid includes a solvent included in the ink, the affinity of the ink with respect to the pretreatment liquid can be further increased. As a result, the action of the pretreatment liquid with respect to the ink can be made more stable. Because the fixability of the ink is further increased, the durability of the recording can be further increased.

### Application Example 7

In the recording method according to the application example, the recording step is performed after the pretreatment liquid applied in the pretreatment step is sufficiently thickened to not flow.

According to this application example, the ink applied in the recording step is applied after the pretreatment liquid applied in the pretreatment is sufficiently thickened to not flow. As a result, because spreading or movement of the ink can be prevented by the pretreatment liquid, aggregation of the ink can be suppressed.

### Application Example 8

In the recording method according to the application example, the ink and pretreatment liquid are applied by being discharged as droplets.

The pretreatment liquid having thixotropy lowers in viscosity when a shear stress is continuously imparted by stirring or imparting oscillation and flows easily. Therefore, the pretreatment liquid being discharged as droplets is easy. The pretreatment liquid having thixotropy thickens when the shear stress is not imparted, and does not easily flow. Therefore, the ink in contact with the thickened pretreatment liquid easily stops at the location thereof. According to this application example, by discharging the ink and pretreatment liquid as droplets, the degrees of freedom in recording with respect to the recording medium or in the expression thereof can be increased.

### BRIEF DESCRIPTION OF THE DRAWINGS

The invention will be described with reference to the accompanying drawings, wherein like numbers reference like elements.

FIG. 1 is a front view of a printer that performs recording with a recording method according to Embodiment 1.

FIG. 2 is a plan view illustrating a condition in which a pretreatment liquid and an ink are applied to the recording medium in a dot shape.

FIG. 3 is a cross-sectional view taken along the line in FIG. 2.

FIG. 4 is a plan view illustrating the range of application of the pretreatment liquid in the recording method according to Example 1.

### DESCRIPTION OF EXEMPLARY EMBODIMENTS

Below, specific embodiments of the invention will be described with reference to the drawings. The following is one embodiment of the invention; however, the invention is not limited thereto. Here, in each of the following diagrams, for convenience of description, there are cases where the scale used in the description is different from that actually used.

### Embodiment 1

### Ink Jet Printer

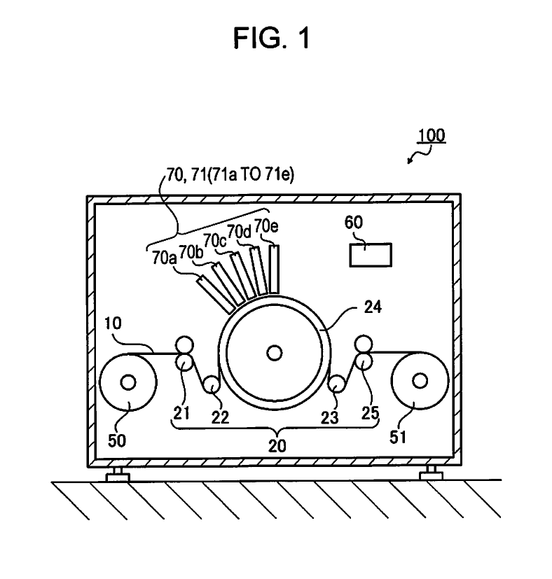

FIG. 1 is a front view of a printer 100 that performs recording with the recording method according to Embodiment 1.

The printer 100 is an ink jet printer which performs recording (printing) while ejecting ink onto a recording medium 10 supplied in a roll state. The printer 100 is provided with a transport unit 20 which transports a recording medium 10, a head unit 70 which discharges the ink or the pretreatment liquid, a supply unit 50 which supplies the pre-recording recording medium 10, a winding unit 51 which winds up the post-recording recording medium, and a controller 60 which controls the overall printer 100.

The printer 100 applies the pretreatment liquid as liquid droplets to the surface (recording surface) of the recording medium 10 prior to performing recording on the recording medium 10 and discharges ink on the recording medium 10 on which the pretreatment liquid is applied, thereby performing recording (printing).

The transport unit 20 is provided with a supply roller 21, transport rollers 22 and 23, a rotary drum 24, a discharge roller 25, and the like, and configures a transport path which transports the recording medium 10 from the supply unit 50 through the recording region below the head unit 70 to the winding unit 51. The rotary drum 24 supports the recording medium 10 during recording. The supply roller 21 and the discharge roller 25 are driving rollers accompanying a nip roller, and the recording medium 10 is transported by driving the driving rollers in a state with the recording medium 10 pinched between the driving roller and the nip roller.

The rotary drum 24 is a cylindrical drum supported to be rotatable by a support mechanism (not shown). The rotary drum 24 supports the recording medium 10 on the outer peripheral surface thereof from the rear surface side of the recording medium 10, that is, from the opposite side to the head unit 70. The rotary drum 24 is driven to rotate by the frictional force between the outer peripheral surface and the recording medium 10 when the recording medium 10 is sent along the outer peripheral surface of the rotary drum.

In the path in which the recording medium 10 is supported on the outer peripheral surface of the rotary drum 24 in the transport path from the supply roller 21 as far as the discharge roller 25, the head unit 70 discharges the pretreatment liquid and ink to the recording medium 10.

The head unit 70 is provided with a first head unit 70a, a second head unit 70b, a third head unit 70c, a fourth head unit 70d, and the fifth head unit 70e. Each head unit is arranged disposed around the rotary drum 24 (positions at substantially the same distance from the outer peripheral surface of the rotary drum 24) from the upstream side in the transport direction of the recording medium 10 in order from the first head unit 70a to the fifth head unit 70e. The transport direction is a direction which passes through the recording region under the head unit 70 from the supply unit 50, and in which the recording medium 10 moves towards the winding unit 51.

The head unit 70 (70a to 70e) is formed including ink jet heads 71 (71a to 71e) which have a plurality of nozzles which discharge the ink or the pretreatment liquid as droplets with an ink jet method. The nozzles are arranged as nozzle rows lined up in the width direction of the rotary drum 24. That is, each head unit 70a to 70e forms a line-type head.

A piezo method is used as a favorable example of the ink jet method (method which discharges liquid droplets). The piezo method is a method where pressure is applied to a liquid (ink, pretreatment liquid) stored in the pressure chamber in response to a recording information signal by means of a piezo element as a piezoelectric element, and the liquid droplets are discharged (ejects) from a nozzle which communicates with the pressure chamber, thereby performing printing.

The head units 70a to 70e discharge, in order, the pretreatment liquid, black ink, yellow ink, cyan ink, and magenta ink.

The color of ink discharged from each of the head units 70b to 70e is not particularly limited. The number of head units 70, that is, the number of colors of pretreatment liquid and ink discharged is also not limited.

The controller 60 controls each of the transport unit 20, the head unit 70, the supply unit 50, and the winding unit 51 based on recording data received from an externally connected device (for example, a personal computer), and records (prints) an image on the recording medium 10. The received recording data is data for recording in which general RGB digital image information obtained by a digital camera or the like is subjected to conversion processing so that recording by a printer 100 is possible through software or the like such as image processing application or printer driver that an externally connected is provided with, and includes commands that control the printer 100.

### Recording Medium

Although an ordinary paper is used as a favorable example of the recording medium 10, there is no limitation thereto, and the recording medium may be surface processed papers such as coated paper, art paper, and cast coated paper, and resin films such as vinyl chloride sheets or PET films, cloth, wooden sheets, plastic sheets, and metals sheets or the like, without being limited to transparent or non-transparent.

### Ink

It is preferable that the ink used in the printer 100 contain a plurality of organic solvent types. An example of a function of the organic solvent is preventing clogging or discharge defects by suppressing the drying or solidification of ink at the nozzle surface (surface of the nozzle plate in which the openings at the end of a plurality of nozzles are lined up in the form of rows) of the ink jet head 71.

Examples of the organic solvent include polyalcohols. Examples of the polyalcohols include ethylene glycol, diethylene glycol, propylene glycol, dipropylene glycol, 1,3-propanediol, 1,4-butanediol, 1,6-hexanediol, and glycerin.

The ink may contain 1,2-alkane diol. The 1,2-alkane diols increase the wettability and permeability with respect to the recording medium 10.

Examples of the 1,2-alkane diol include 1,2-propanediol, 1,2-butanediol, 1,2-pentanediol, 1,2-hexanediol, and 1,2-octanediol.

The ink may contain a pyrrolidone derivative. The pyrrolidone derivative acts as a favorable solvent of the recording medium 10, and is able to improve the fixability of the ink with respect to the recording medium. Examples of the pyrrolidone derivatives include N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone.

A surfactant may be included in the ink. Examples of favorable surfactants include at least one type of fluorine-based surfactant, acetylene glycol-based surfactant, and silicon-based surfactant. When these surfactants are blended into the ink, the wettablity on the recording medium 10 is increased and it is possible for the permeability of the ink to the recording medium to be improved.

Other surfactants such as anionic surfactants, nonionic surfactants, and amphoteric surfactants may be added to the ink.

It is preferable that the ink contain at least one type selected from pigments, dyes, metal oxides, and particles having a hollow structure as coloring materials.

Although not particularly limited, examples of usable pigments include inorganic pigments and organic pigments.

It is possible for Carbon blacks (C.I. Pigment Black 7) such as furnace black, lamp black, acetylene black, and channel black, iron oxide, and titanium oxide to be used as the inorganic pigment.

Examples of the organic pigment include, azo pigments such as insoluble azo pigments, condensed azo pigments, azo lake, and chelate azo pigments; polycyclic pigments such as phthalocyanine pigments, perylene and perynone pigments, anthraquinone pigments, quinacridone pigments, dioxane pigments, thioindigo pigments, isoindolinone pigments, and quinophthalone pigments; and chelate dyes (for example, a basic dye-type chelate, an acidic dye-type chelate, or the like), lake dyes (for example, a basic dye-type lake, an acid dye-type lake), nitro pigments, nitroso pigments, aniline black, and daylight fluorescent pigments. The pigments may be used independently or two or more types may be used together.

Examples of the dyes that may be used include the various types of dye which are normally used in ink jet recording, such as direct dyes, acid dyes, food dyes, basic dyes, reactive dyes, disperse dyes, vat dyes, soluble vat dyes and reactive dispersed dyes.

A dispersant for causing the pigment to be dispersed may be added when a pigment is contained in the ink. It is possible to use a dispersant commonly used in the adjustment of a pigment dispersion liquid, for example, a macromolecular dispersant as a preferred dispersant. It is possible to use an arbitrary dispersant used in ordinary inks as such a dispersant.

The ink may further contain a pH adjuster, a resin such as polyolefin wax, a fungicide and preservative, a rust inhibitor, a chelating agent, and the like as additives. When these materials are added, it is possible for the characteristics the ink has to be further improved.

### Pretreatment Liquid

The pretreatment liquid is a liquid which has affinity to the above-described ink and has thixotropy. Specifically, the pretreatment liquid is a liquid which is imparted with thixotropy by adding carboxymethyl cellulose to a base liquid formed from respective materials contained in the above-described organic solvent, pyrrolidone derivative, surfactant each of the additives and the ink.

It should be noted that the material added in order to impart thixotropy is not limited to carboxymethyl cellulose.

### Recording Method

Next, the recording method which performs recording with the printer 100 using the above-described ink and pretreatment liquid will be described.

First, the recording medium 10 is set in the printer 100 as a reference step. As illustrated in FIG. 1, the recording medium 10 is suspended from the supply unit 50 as far as the winding unit 51 via the transport path passing the rotary drum 24 (printing region below the head unit 70), and is set at the recording start position.

Next, when the printer 100 receives instructions (recording data) from the externally connected device (for example, a personal computer), the controller 60 performs control in which the pretreatment liquid is discharged from the first head unit 70a and control in which the recording head 10 is moved in the transport direction, and applies the pretreatment liquid on the recording medium 10 as a “pretreatment step”.

At this time, the position (range) at the controller 60 applies the pretreatment liquid is a sufficient range necessary for performing recording with respect to the recording medium 10. Specifically, the controller 60 performs control so that the pretreatment liquid is applied with respect to the entire recordable range based on the vertical and horizontal size (size such as JIS standard A0 or B0) of the recording included in the recording data.

More specifically, in the pretreatment step, the first head unit 70a forms dots with the pretreatment liquid spanning a predetermined recording ranged in the width direction of the recording medium 10 at a pitch based on a predetermined nozzle pitch of the nozzle rows provided in the first head unit 70a. After the rows of dots are formed with the pretreatment liquid, the recording medium 10 moves an equivalent length to the pitch of the dots formed in the transport direction. By alternately repeating the discharge and movement operations, the dots of the pretreatment liquid are formed at predetermined interval, that is, in a matrix form spanning the entire surface of the recording range with respect to the recording medium 10. It should be noted that the application of the pretreatment liquid may be a method of repeating the discharge at a constant interval on the recording medium 10 transported at a constant speed, rather than alternately repeating the discharge and movement operations.

In this way, the recording medium 10 on which the pretreatment liquid is applied subsequently moves in the transport direction, and the printer 100 discharges ink from each of the head units 70b to 70e as the “recording step” according to the controller 60 based on the recording data, thereby performing a desired recording.

Here, the pretreatment liquid landed on the recording medium 10 increases in viscosity over time due to the thixotropy thereof. It is necessary that the pretreatment liquid reaches a predetermined viscosity or higher in order to obtain a predetermined or higher function (described later) of the pretreatment liquid with respect to the recording. Specifically, the recording step is performed after the pretreatment liquid is sufficiently thickened to not flow. That is, the printer 100 is formed so that ink is applied after a predetermined time passes from the pretreatment liquid being applied. Specifically, the printer 100 is formed so that, after the pretreatment liquid discharged from the first head unit 70a by a shear stress being imparted according to the spacing between the first head unit 70a and the second head unit 70b and the transport speed of the recording medium 10 therebetween is landed on the recording medium 10, a sufficient time necessary for the pretreatment liquid to thicken enough to not flow again passes until the ink is discharged from the second head unit 70b.

### Function of Pretreatment Liquid

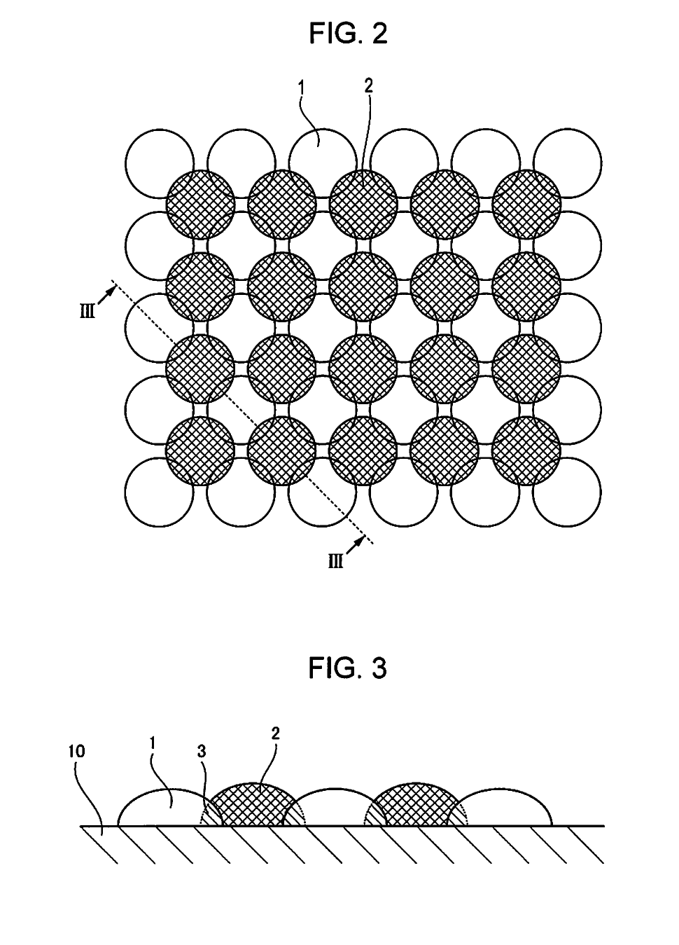

FIG. 2 is a plan view schematically illustrating a condition in which a pretreatment liquid and an ink are applied to the recording medium 10 in a dot shape. FIG. 3 is a cross-sectional view taken along the line in FIG. 2. In FIGS. 2 and 3, 1 indicates the pretreatment liquid and 2 indicates the ink. 3 indicates the region in which the pretreatment liquid 1 and the ink 2 are mixed. The example in FIGS. 2 and 3 indicate a situation in which the ink droplets are discharged to a position surrounded in four directions by dots (droplets) of the pretreatment liquid 1.

As described above, because the pretreatment liquid 1 is included in the solvent included in the ink 2 and has affinity to the ink 2, when the ink 2 is applied to be in contact with the pretreatment liquid 1, the ink 2 and the pretreatment liquid 1 in the region of contact are mixed, and the viscosity of the region 3 in which they mix rises. This is because, the pretreatment liquid 1 is already thickened enough to not flow when the ink 2 is applied to the recording medium 10, and because the component which imparts the thixotropy to the pretreatment liquid 1 (for example, carboxymethyl cellulose) is dispersed in the ink 2, and thixotropy is also imparted in no small measure to the ink 2.

In this way, the movement of the ink 2 is prevented by the ink 2 being in contact with the pretreatment liquid 1 which is sufficiently thickened to not flow, and the viscosity of the region 3 where mixed with the pretreatment liquid 1 increasing. That is, by applying the pretreatment liquid 1 in advance to the recording surface of the recording medium 10, the phenomena of the ink 2 spreading (or moving) on the recording surface of the recording medium 10, and aggregation according to the surface tension with the adjacent ink 2 are prevented.

As described above, according to the recording method of the embodiment, it is possible to obtain the following effects.

The ink applied in the recording step is applied to the recording medium 10 on which the pretreatment liquid having thixotropy is applied. Therefore, it is possible for behavior of the ink applied to the recording medium 10 to be controlled based on the thixotropy of the pretreatment liquid. That is, the degree of spreading and movement of the ink can be controlled in response to the thickness characteristics of the pretreatment liquid. As a result, it is possible to suppress aggregation of the ink. That is, aggregation or bleeding of the ink can be suppressed without including a component that reacts with both of the pretreatment liquid and the ink.

The ink applied in the recording step is applied to the recording medium 10 on which the pretreatment liquid having thixotropy is applied at predetermined intervals. Therefore, in a case where the viscosity of the pretreatment liquid when the ink is applied is high enough to prevent spreading or movement of the ink, aggregation of the ink can be suppressed by the pretreatment liquid applied at predetermined intervals.

Because the pretreatment liquid has affinity to the ink, it is possible for the action of the pretreatment liquid with respect to the ink to be further stabilized. Because the fixability of the ink is further increased, the durability of the recording can be further increased.

Because the pretreatment liquid includes a solvent included in the ink, it is possible to further increase the affinity of the ink with respect to the pretreatment liquid. As a result, the action of the pretreatment liquid with respect to the ink can be made more stable. Because the fixability of the ink is further increased, the durability of the recording can be further increased.

The ink applied in the recording step is applied after the pretreatment liquid applied in the pretreatment step is sufficiently thickened to not flow. As a result, because it is possible for spreading or movement of the ink to be prevented by the pretreatment liquid, it is possible to suppress aggregation of the ink.

The pretreatment liquid having thixotropy lowers in viscosity when a shear stress is continuously imparted by stirring or imparting oscillation and flows easily. Therefore, the pretreatment liquid being discharged as droplets is easy. The pretreatment liquid having thixotropy thickens when the shear stress is not imparted, and does not easily flow. Therefore, the ink in contact with the thickened pretreatment liquid easily stops at the location thereof. The degrees of freedom in recording with respect to the recording medium 10 or in the expression thereof can be increased by discharging the ink and pretreatment liquid as droplets.

It should be noted that the invention is not limited to the above-described embodiments, and various modifications, improvements, and the like can be added to the above-described embodiments. Modification examples are described below. Here, the same reference numerals will be used for the same constituent parts as the above-mentioned embodiments, and overlapping description thereof will be omitted.

### Example 1

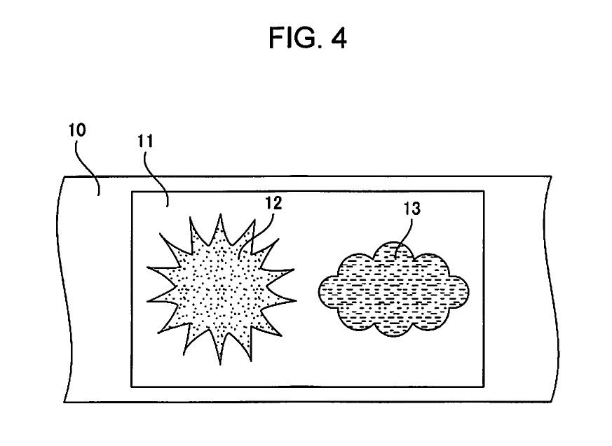

FIG. 4 is a plan view illustrating the range of application of the pretreatment liquid in the recording method according to Example 1.

In FIG. 4, 11 indicates the range in which recording is able to be performed with respect to the recording medium 10, and 12 and 13 indicate the images which are recorded. That is, a situation is illustrated where the printer 100 records the image 12 and the image 13 in the recording range 11 with respect to the recording medium 10.

Although the position (range) at which the pretreatment liquid is applied in embodiment 1 is described as a sufficient range necessary for performing recording with respect to the recording medium 10, that is, a range (for example, entire recording range 11 in FIG. 4) based on information of the vertical and horizontal size of the recording included in the recording data, there is no limitation thereto. For example, a method of applying the pretreatment liquid to only the position (range) of the images 12 and 13 which are recorded as illustrated in FIG. 4 may be used.

Specifically, when the printer 100 receives the recording data, the controller 60 analyzes the information of the image position included in the recording data and controls the first head unit 70a to apply the pretreatment liquid only to the region corresponding to the image position.

It should be noted here that the wording “image position” is not limited to an image having a specific shape, such as the images 12 and 13 illustrated in FIG. 4. For example, a region in which a specified ink is applied or a region in which recording of a specified color is performed may be used.

According to the recording method according to the modification example, it is possible for the step of applying of the pretreatment liquid to be shortened or the consumption amount of the pretreatment liquid to be reduced by applying the pretreatment liquid only to a sufficient range in which recording is necessary. For example, by applying the pretreatment liquid only to the range in which the effects or influence due to the pretreatment liquid is expected in response to the image to be recorded, the color to be recorded or the like, the width of expression in the recording can be widened.

### Example 2

In Embodiment 1, forming dots of the pretreatment liquid are in a matrix form at predetermined intervals in the pretreatment step was described. That is, although an example in which the pretreatment liquid is applied at a constant density was described, there is no limitation thereto. For example, in the case of the description using FIG. 4, application may be performed so that the densities of the pretreatment liquid applied to each of the regions of the remaining region in images 12 and 13 and the recording range 11 differ.

For example, a method of performing the application to form dots of the pretreatment liquid in a matrix form at predetermined intervals to the region of the image 12 as illustrated in FIG. 2, and performing the application in the remaining region in the recording range 11 at one half the density of the region of image 12, without applying the pretreatment liquid to the region of the image 13 may be used. In a case of applying the pretreatment liquid with such a form, the region of the image 12 obtains an image with good graininess in which aggregation or bleeding of the ink, or the like, is suppressed and the region of the image 13 obtains an image with expression using the aggregation or bleeding of the ink. It is possible for the information of the respective densities to be designated as the form in the recorded recording by software such as the above-described image processing application or printer driver.

According to the recording method according to the modification example, the pretreatment liquid having thixotropy is applied at a density based on the recording recorded in the recording step. That is, it is possible to apply the pretreatment liquid at a density in response to the degree of effect and influence due to the pretreatment liquid expected. As a result, it is possible to widen the width of expression during recording.

This application claims priority under 35 U.S.C. 119 to Japanese Patent Application No. 2015-174440, filed Sep. 4 2015. The entire disclosure of Japanese Patent Application No. 2015-174440 is hereby incorporated herein by reference.

What is claimed is:

1. A recording method that performs recording by applying ink to a recording medium, the method comprising:
pretreatment step that applying a pretreatment liquid having thixotropy to the recording medium; and
recording step that applying the ink to the recording medium to which the pretreatment liquid is applied.

2. The recording method according to claim 1,
wherein, in the pretreatment step, the pretreatment liquid is applied to the recording medium at predetermined intervals.

3. The recording method according to claim 1,
wherein, in the pretreatment step, the pretreatment liquid is applied at a position according to a recording which is recorded in the recording step.

4. The recording method according to claim 1,
wherein, in the pretreatment step, a density at which the pretreatment liquid is applied changes based on the recording which is recorded in the recording step.

5. The recording method according to claim 1,
wherein the pretreatment liquid has affinity to the ink.

6. The recording method according to claim 1,
wherein the pretreatment liquid includes a solvent included in the ink.

7. The recording method according to claim 1,
wherein the recording step is performed after the pretreatment liquid applied in the pretreatment step is sufficiently thickened to not flow.

8. The recording method according to claim 1,
the ink and pretreatment liquid are applied by being discharged as droplets.
